(19) United States
(12) Patent Application Publication
(10) Pub. No.: US 2013/0275572 A1
(43) Pub. Date: Oct. 17, 2013

(54) Method for setting up temporary readiness of a field device to receive data and measuring system

(71) Applicant: VEGA GRIESHABER KG, Wolfach (DE)

(72) Inventors: Ralf SCHAETZLE, Fischerbach (DE); Fridolin FAIST, Oberwolfach (DE); Andreas ISENMANN, Haslach (DE)

(73) Assignee: VEGA Grieshaber KG, Wolfach (DE)

(21) Appl. No.: 13/852,264

(22) Filed: Mar. 28, 2013

Related U.S. Application Data
(60) Provisional application No. 61/622,621, filed on Apr. 11, 2012.

(30) Foreign Application Priority Data
Apr. 11, 2012 (EP) 12 163 749.0

(51) Int. Cl. G06F 15/173

(52) U.S. Cl. CPC H04L 41/08
USPC 709/223

(57) ABSTRACT

A method is for setting up temporary readiness of a field device for process automation to receive data in which a time interval is communicated to the field device during which it should be in transmit/receive mode. After expiry of this time interval, the field device switches back to a power-saving mode. As this time interval is freely selectable by a remote user, it is possible as a result to specify a suitable time for field device maintenance. As a result, it is possible to facilitate field device maintenance of battery-operated field devices which are in power-saving mode for the majority of the time.

### REFERENCE TO RELATED APPLICATIONS

This application claims the benefit of the filing date of EP Patent Application Serial No. EP 12 163 749.0 filed 11 Apr. 2012 and U.S. Provisional Patent Application Ser. No. 61/622,621 filed 11 Apr. 2012, both disclosures of which are hereby incorporated by reference.

### FIELD OF THE INVENTION

The invention relates to measuring systems with field devices for process automation. In particular, the invention relates to a method for setting up temporary readiness of a field device for process automation to receive data, a field device for measuring a process variable, a server for a field device, a measuring system with a field device and a server, program elements and a machine-readable medium.

### TECHNOLOGICAL BACKGROUND

With a measuring system, such as the VEGA WEB-VV for example, field devices transmit measured values to a central server via the Internet. Data transfer by the field device can be time- or event-driven. The transmission time, the transmission interval or the transmission event is set locally in the field device by appropriate parameterisation during commissioning of the field device.

It is necessary for the field device to be accessible in order, for example, to change these settings at a later date. If the field devices are mains-fed field devices with a connected modem, they can be contacted remotely at any time via a wireless communication link.

However, if the field device is a battery-operated measuring instrument, such as the VEGA PLICSMOBILE, this field device is usually set up so that it only transmits data to the WEB-VV server once a day and is otherwise in power-saving mode. In power-saving mode, the field device is not accessible remotely, via a GSM/GPRS link for example. In this case, changes in the device can only be performed directly on-site.

Changes for the field device can be stored temporarily on a server and then transmitted to the field device by the server when the field device establishes a connection.

### SUMMARY OF THE INVENTION

According to a first aspect of the invention, a field device for measuring a process variable which has a transmit/receive unit and a control unit is specified. The transmit/receive unit is designed for transmitting data to an external server or another receiver and for receiving data from the server or the other receiver. The control unit is used to transfer the field device from so-called power-saving mode to a transmit/receive mode. The control unit can also transfer the field device from transmit/receive mode to power-saving mode when the time interval for the communication between field device and server has expired.

If the field device is in the transmit/receive mode, the server can transmit information to the field device which defines a later time for transferring the field device from power-saving mode to transmit/receive mode.

In other words, once the field device has established a connection to the server, the server can tell the field device when (i.e. at what time) it should change from power-saving mode to transmit/receive mode.

Thus, the server itself can determine the time window for a later communication with the field device and communicate this to the field device. The field device is then remotely accessible within this time window such that remote maintenance of the field device, for example, can take place.

The appropriate selection of the time window by the server can be advantageous in those cases, for example, in which a malfunction of the field device occurs regularly at a certain time of the day that is outside the normal time interval for data exchange between server and field device. If the server then specifies the time interval for a data exchange at this specific time, the error can be analysed more accurately and measures can be taken as a result to remedy this error.

In other words: The server communicates at least the starting time of a future data transfer, i. e. the time at which the field device has to switch into the transmit/receive mode. This communication is performed only if (i) the field device is in the transmit/receive mode, (ii) a communication connection between the field device and the server is established, (iii) the field device has completed a transmission of measured data to the server, and (iv) the server is aware that an extra, additional time interval for data transfer between the field device and the server is required.

According to an embodiment of the invention, the field device has a power supply internal to the field device. For example, this can be a battery or a rechargeable battery. Solar cells can be provided alternatively or additionally.

For example, the field device is not connected to an external power supply. Naturally, it is also possible for the field device to be hardwired and connected to a data bus via which it can also be supplied with electric power. Alternatively or in addition to connection to the data bus, a wireless interface can be provided in the form of a radio modem with the help of which the field device can communicate wirelessly with the server. This wireless interface can then be used for remote maintenance.

According to a further embodiment of the invention, the transmit/receive unit is therefore designed to wirelessly transmit and receive the data.

According to a further embodiment of the invention, the field device is a level measuring instrument, a pressure measuring instrument or a flow measuring instrument.

In particular, the field device can also be a level radar which transmits free-radiating electromagnetic waves or which is based on the principle of guided microwaves.

According to a further aspect of the invention, a server is specified for a field device described above and in the following.

For example, the server has a data storage device in which information about the later time for transferring the field device from power-saving mode to transmit/receive mode is stored.

According to a further aspect of the invention, a measuring system is specified which has one or more of the field devices described above and in the following and a server described above and in the following. The individual components of the measuring system can communicate with each other via the Internet. The measuring system can also have service PCs and customer PCs which can communicate with the field device and/or the server in order, for example, to carry out remote maintenance on the field device, fault diagnosis, field device parameterisation or measured value retrieval.

According to a further aspect of the invention, a method is specified for setting up temporary readiness to receive of a field device for process automation in which information for a time for transferring the field device from a power-saving mode to a transmit/receive mode is stored in a server. This information, for example, can merely specify the start time for transmit/receive mode. However, this information can also specify a complete time interval during which the field device is in transmit/receive mode. After this time interval expires, it then switches back to power-saving mode.

The server can generate this information itself, for example if it determines that the field device is not working properly at a certain time of the day. This information can also be generated by a user who, for example, would like to carry out maintenance of the field device at a specific time.

The field device changes, for example, time-driven and/or event-driven from power-saving mode to transmit/receive mode. After this, the field device establishes a connection to the server in order to transmit measured data to the server. These measured data or measured values are then received in the server and at this point (or shortly beforehand or shortly thereafter) the server can transmit information to the field device. This information relates to the time described above for transferring the field device from power-saving mode to transmit/receive mode.

Thereupon, the field device terminates the connection with the server and changes from transmit/receive mode to power-saving mode. When the time specified by the server is then reached, the field device automatically changes back from power-saving mode to transmit/receive mode so that remote maintenance, for example, can take place. When the end time of the time window provided for transmit/receive mode is reached, the field device changes back to power-saving mode.

According to an embodiment of the invention, the time window can be optionally lengthened or shortened while the field device is in transmit/receive mode. This lengthening or shortening of the time window can be triggered, for example, by a remote user or can take place automatically if the field device determines that the remote maintenance has not yet been completed. Once the process of remote maintenance is finished, the server or the corresponding user PC transmits a signal to the field device whereupon it then assumes power-saving mode again. Thus, in this case, the field device is requested to switch back to power-saving mode by an external entity.

According to a further aspect of the invention, program elements are specified which, if they are executed on processors of a measuring system, instruct the measuring system to perform the steps described above and in the following.

The same program elements can be stored on the various processors of the measuring system. It is also possible for individual processors to have different program elements. For example, the program elements stored in the server can be different to the program elements stored in the field device as both components must accomplish different tasks. Collectively, all the program elements cooperate in such a manner that the measuring system can carry out the method steps according to the invention.

According to a further aspect of the invention, a machine-readable medium is specified on which the program elements described above and in the following are stored.

The program elements can be part of software that is stored on the processors of the measuring system. At the same time, the processors can likewise be the subject matter of the invention. The invention further comprises program elements which use the invention from the outset and also program elements which as a result of an update initiate an existing program for using the invention.

Embodiments of the invention will be described in the following with reference to the figures.

### BRIEF DESCRIPTION OF THE FIGURES

FIG. 1 shows a measuring system 100 according to an embodiment of the invention.

FIG. 2 shows a timing diagram of a method according to an embodiment of the invention.

FIG. 3 shows a flow chart of a method according to an embodiment of the invention.

FIG. 4 shows various field devices according to embodiments of the invention.

The illustrations in the figures are schematic and not to scale.

If identical reference numerals are used in different figures in the following description of the figures, they describe the same or similar elements. The same or similar elements, however, can also be described by different reference numerals.

### DETAILED DESCRIPTION

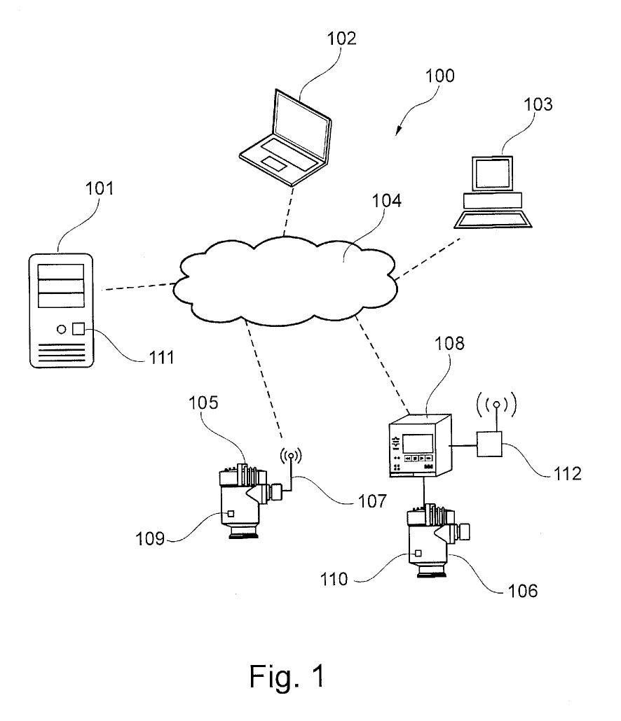

FIG. 1 shows a measuring system 100 according to an embodiment of the invention. Measuring system 100 is, for example, a VEGA WEB-VV system which has a WEB-VV server 101, a service PC 102, a customer PC 103, a first field device in the form of a sensor 105 and a second field device in the form of an evaluation and operating unit 108 with connected sensor 106. All components of the measuring system are linked to each other via the Internet 104.

In this system, sensor 105 or evaluation and operating unit 108, to which sensor 106 is connected, transmits event-driven measured values to WEB-VV server 101. WEB-VV server 101 stores the measured values in a database 111. The measured values can be called up from customer PC 103 or service PC 102 via the Internet 104 by means of a web browser.

Field device 105 has a wireless interface 107 in the form of a transmit/receive unit for wireless communication with the server, the customer PC or the service PC. The field device further has a control unit 109 which is designed to control the measuring program.

Field device 106 and/or evaluation and operating unit 108 also has a corresponding control unit 110, 113. Field device 106 is connected to evaluation and operating unit 108 which is connected in turn to external wireless interface (transmit/receive unit) 112.

In addition to this, the field devices can also be linked to a data bus.

If sensor 105 or sensor 106 with evaluation and operating unit 108 are in transmit/receive mode, it is possible to access the devices using service PC 102 and the software installed thereon for operating the devices (e.g. PACTware/DTM). It is then possible to read off diagnostic information, change settings and carry out software updates.

Sensor 105 is a sensor with integrated radio module, for example in the form of a GPRS modem 107, and a battery supply. When operating in “power-saving mode”, sensor 105 has different operating modes, i.e. a transmit/receive mode and a power-saving mode.

In transmit/receive mode, sensor 105 can transmit data, for example measured values, to WEB-VV server 102. In this mode, it is also possible to reach the sensor via the Internet using a service PC 102 in order to retrieve or change data.

In power-saving mode, the radio module of sensor 105 is deactivated in order to save power. As radio module 107 of sensor 105 is switched off, it is not possible in this mode to reach the sensor via the Internet. In order to transmit measured values, the sensor changes event-driven (for example, time-driven or measured value-driven) to transmit/receive mode. Once the data have been transmitted, the sensor automatically returns to power-saving mode. Since the sensor only changes to transmit/receive mode for a short time, the running time until replacement of the battery increases considerably as a result.

A disadvantage of this mode of operation may be that the sensor cannot be reached by external devices, such as the server for example, in power-saving mode.

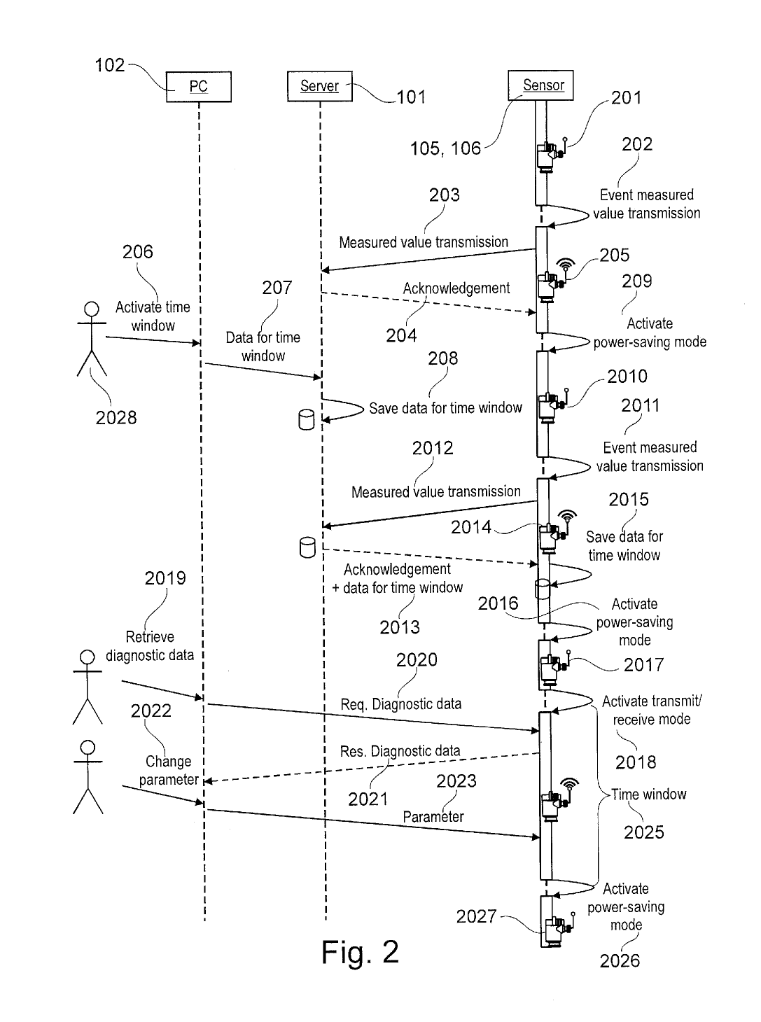

To make this possible, sensor 105 (and incidentally of course also evaluation and operating unit 108 with connected sensor 106) can be transferred remotely to transmit/receive mode within a specified time window. The method illustrated in FIG. 2 is used for this.

It can be seen in FIG. 2 that the sensor is initially in power-saving mode 201. A measured value transmission 202 is triggered by an event (the reaching of a specific time for example). For this to happen, the sensor changes to transmit/receive mode 205 and starts measured value transmission 203 to the WEB-VV server. The WEB-VV server acknowledges the receipt of measured value data 204. After acknowledgement, the sensor changes back to power-saving mode 209, 2010.

Due to a problem with the measurement which, for example, always occurs at the same time, service technician 2028 requires access to the sensor and at precisely the time at which the problem occurs. However, as the sensor is in power-saving mode, no access can take place. So that access can take place at a specific time, service technician 2028 activates a time window for the sensor during which the sensor changes to transmit/receive mode. However, as the sensor is not currently accessible, the data for the time window are initially stored temporarily on the WEB-VV server as indicated by arrows 206, 207, 208.

As soon as the sensor changes to transmit/receive mode (2011) due to a measured value transmission and transmits measured values to the WEB-VV server (2012), the data for the time window are also transmitted in addition to the acknowledgement (2013). The sensor saves these data (2015) and sets an alarm for the start time of time window 2025.

Afterwards, the sensor changes back to power-saving mode 2016, 2017. As soon as the start time of time window 2025 is reached, the sensor changes to transmit/receive mode 2018. In this mode the sensor is now accessible via the Internet. The service technician can now use the PC to call up diagnostic data from the sensor directly via the Internet as is symbolised by arrows 2019, 2020 and 2021.

Based on the diagnostic data, the service technician can now also change parameters in the sensor (2022 and 2023). After expiry of time window 2025, the sensor automatically changes back to power-saving mode 2026, 2027. The change can also be delayed as long as data are still being exchanged between the sensor and the PC. Similarly, the time window can also be shortened if the service technician has finished the maintenance early.

This is therefore a method for remotely activating a time window for transmitting and receiving data to a field device. The field device, for example, is a battery-fed device that normally only transmits data to a remote server in a short time interval. The device is not accessible for the remaining time as it is in power-saving mode and in this state it can neither receive nor transmit data.

Using this method, it is possible to tell the device remotely that it should change from power-saving mode to receive mode at a specific time so that it is remotely accessible for parameterisation, updating or diagnostic purposes.

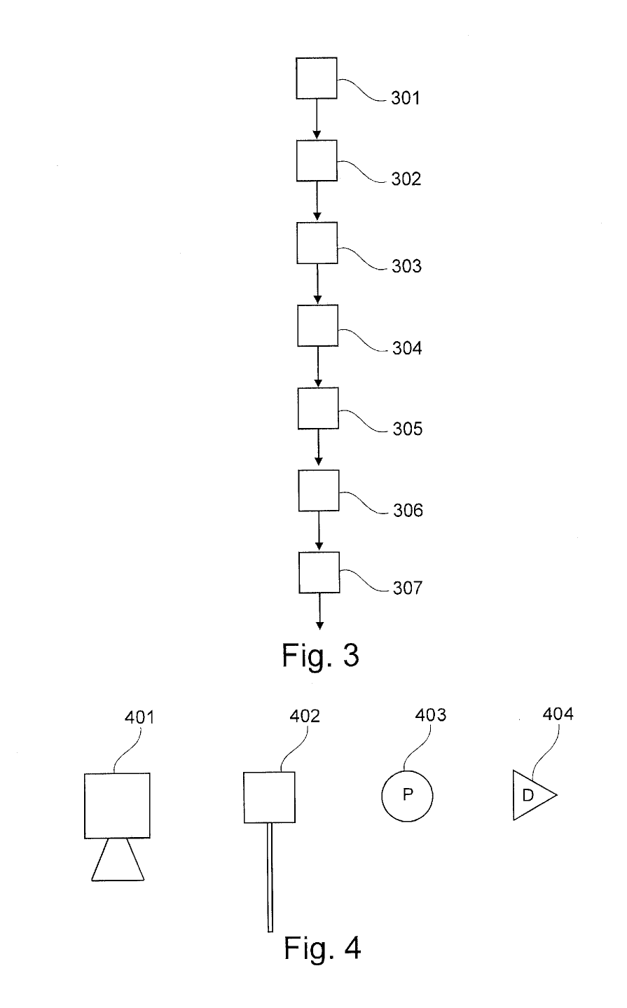

FIG. 3 shows a flow chart of a method according to an embodiment of the invention. In step 301, data for the time window for transmit/receive mode are stored in the server. In step 302, the field device changes time- or event-driven from power-saving mode to transmit/receive mode and establishes connection with the server in order to transmit measured data to it. In step 303, the server receives the measured data and communicates the stored data for the time window to the field device. In step 304, the field device receives the data for the time window and subsequently terminates the connection with the server again. The field device changes back to power-saving mode.

In step 305, the start time of the time window is reached and the field device automatically changes from power-saving mode to transmit/receive mode.

In step 306, the field device is remotely accessible from this time up to the end of the time window. Data can now be read or written in the field device. Such data can be, for example, diagnostic information, such as echo curves.

In step 307, the end time of the time window is reached and the field device automatically changes back again to power-saving mode. There is, however, the facility to lengthen or shorten this time window manually or automatically while the field device is still in transmit/receive mode.

Thus there is a possibility to remotely specify the time window for transmit/receive mode. In this way it is possible to obtain access to the field device at a specific time. The requirement is that the time window comes after the next time for a measured data transmission between the field device and the server.

FIG. 4 shows various field devices which can be designed to perform the method according to the invention. Here this is a level radar 401 which transmits free-radiating electromagnetic signals. The field device can also be a measuring instrument 402 which transmits guided microwaves. Moreover, the field device can also be a pressure measuring instrument 403 or a flow measuring instrument 404.

It should be pointed out additionally that “comprising” and “having” do not exclude any other elements or steps and “a” does not exclude a plurality. It should further be pointed out that features or steps which have been described with reference to one of the above exemplary embodiments can also be used in combination with other features or steps of other exemplary embodiments described above. Reference numbers in the claims are not to be considered as restrictions.

1. A field device for measuring a process variable, comprising:
a transmit/receive unit transmitting data to a server and receiving further data from the server; and
a control unit transferring the field device from a power-saving mode to a transmit/receive mode and vice versa,
wherein the control unit received from the server time data about a later time for transferring the field device from the power-saving mode to the transmit/receive mode while the field device is in the transmit/receive mode.

2. The field device according to claim 1, further comprising:
a power supply situated inside of the field device.

3. The field device according to claim 1, wherein the transmit/receive unit is configured to communicate wirelessly.

4. The field device according to claim 1, wherein the field device includes at least one of a level measuring instrument, a pressure measuring instrument and a flow measuring instrument.

5. A server for a field device according to claim 1, comprising:
a processor; and
a communication unit configured to communicate with the field device.

6. The server according to claim 5, further comprising:
a data storage device storing the time data about the later time for transferring the field device from power-saving mode to transmit/receive mode.

7. A measuring system, comprising:
a field device according to claim 1; and
a server according to claim 5.

8. A method for setting up temporary readiness of a field device for process automation to receive data, comprising the following steps:
storing of time data for a time for transferring the field device from a power-saving mode to a transmit/receive mode in a server;
time- or event-driven transferring of the field device from the power-saving mode to the transmit/receive mode;
connecting the field device to the server in order to transmit measured data to the server;
receiving the measured data in the server;
transferring the time data from the server to the field device;
terminating the connection between the field device and the server;
transferring the field device from the transmit/receive mode to the power-saving mode;
transferring the field device from the power-saving mode to the transmit/receive mode when the time is reached; and
transferring the field device to the power-saving mode after reaching an end time of a time window provided for the transmit/receive mode.

9. The method according to claim 8, further comprising the step:
adjusting the time window during which the field device is in the transmit/receive mode.

10. Program elements which, when they are executed on one or more processors of a measuring system, instruct the measuring system to perform the following steps:
storing of information for a time for transferring a field device from a power-saving mode to a transmit/receive mode in a server;
time- or event-driven transferring of the field device from the power-saving mode to the transmit/receive mode;
connecting the field device to the server in order to transmit measured data to the server;
receiving the measured data in the server;
transferring the information from the server to the field device;
terminating the connection between the field device and the server;
transferring the field device from the transmit/receive mode to the power-saving mode;
transferring the field device from the power-saving mode to the transmit/receive mode when the time is reached;
transferring the field device to the power-saving mode after reaching an end time of a time window provided for the transmit/receive mode.

11. A machine-readable medium on which are stored program elements which, if they are executed on processors of a measuring system, instruct the measuring system to perform the following steps:
storing of information for a time for transferring a field device from a power-saving mode to a transmit/receive mode in a server;
time- or event-driven transferring of the field device (from the power-saving mode to the transmit/receive mode;
connecting the field device to the server in order to transmit measured data to the server;
receiving the measured data in the server;
transferring the information from the server to the field device;
terminating the connection between the field device and the server;
transferring the field device from the transmit/receive mode to the power-saving mode;
transferring the field device from the power-saving mode to the transmit/receive mode when the time is reached;
transferring the field device to the power-saving mode after reaching an end time of a time window provided for the transmit/receive mode.
